(19) United States
(12) Patent Application Publication
(10) Pub. No.: US 2026/0094452 A1
(43) Pub. Date: Apr. 2, 2026

(54) METHOD FOR MONITORING A TRACK SECTION, RAILROAD SYSTEM, COMPUTER PROGRAM PRODUCT AND COMPUTER-READABLE STORAGE MEDIUM

(71) Applicant: Siemens Mobility GmbH, MüNCHEN (DE)

(72) Inventor: Jens Braband, Braunschweig (DE)

(21) Appl. No.: 19/344,862

(22) Filed: Sep. 30, 2025

(30) Foreign Application Priority Data
Sep. 30, 2024 (EP) 24203516.0

(51) Int. Cl. G06V 20/58; G06V 20/52; H04N 23/90

(52) U.S. Cl. CPC G06V 20/58; G06V 20/52; H04N 23/90

(57) ABSTRACT

A method for monitoring a track section for obstacles uses first and second sensors detecting and being aligned with the track section, with each track section location being present in one first sensor image and one second sensor image. The first and second images are analyzed in a computer for obstacles in the track section. A signal indicating an obstacle is always generated if the analysis identified an obstacle in the first and second images. A signal indicating an obstacle, if the analysis identified the obstacle only in the first or only in the second images, is only generated when the analysis identified the obstacle in a critical, not a non-critical, category. A first signal indicating a fault is always generated if the analysis identified the obstacle in only the first or second images. A railroad system, a computer program product and a computer-readable storage medium are also provided.

### CROSS-REFERENCE TO RELATED APPLICATION

This application claims the priority, under 35 U.S. C. § 119, of European Patent Application EP 24203516.0, filed Sep. 30, 2024; the prior application is herewith incorporated by reference in its entirety.

### FIELD OF THE INVENTION

The invention relates to a method for monitoring a track section. Further, the invention relates to a railroad system with a track section. Further, the invention relates to computer program product, containing program commands. Further, the invention relates to a computer-readable storage medium, containing data.

### BACKGROUND OF THE INVENTION

According to the prior art, it is known for platforms to be monitored with the aid of cameras on the platforms or on the train. The camera images are monitored, for example, by the operating staff of a railroad operator, so the rail traffic can be interrupted if an obstacle is discovered on the track section which extends along the platform. Obstacles are taken to mean objects or animate beings having a size which would result in a collision with an oncoming train. Those are foreign bodies on the relevant track section, which can end up on the track section preferably starting from the platform. A similar situation also emerges in the danger zones of railroad crossings.

From the prior art which has been explained, the problem emerges that manual monitoring of sections of track, in particular at platforms and railroad crossings, is labor intensive and thereby cost-intensive. In addition, misjudgments on the part of the staff cannot be ruled out. However, automation of monitoring involves the problem that the task to be managed involves a safety-relevant topic (safety in the context of this description of the invention should be understood within the meaning of operational safety, also called safety), so that automation has to satisfy the safety requirements of rail operation.

Various approaches have been pursued in the past to increase the reliability of obstacle identification in rail traffic. According to European Application EP 4124542 A1 and European Application EP 4299411 A1, corresponding to U.S. Publication No. 2024/0001976 A1, markers, for example, are used for that purpose, which carry information in the form of an encoding for the detection as objects. Those are intended to make obstacle identification, for example in a railroad crossing, safer because the identification of all markers is evaluated as evidence that there is no obstacle present which is concealing the marker. European Application EP 4389558 A1 proposes, moreover, that obstacle identification during operation of a track-guided vehicle can be proven and tested in order to increase the reliability of obstacle identification.

### SUMMARY OF THE INVENTION

It is accordingly an object of the invention to provide a method for monitoring a track section, a railroad system, a computer program product and a computer-readable storage medium, which overcome the hereinafore-mentioned disadvantages and solve the described problems of the heretofore-known devices and methods of this general type.

In particular, it is an object to disclose a method for monitoring a track section with which monitoring can be automated and at the same time a high level of safety can be achieved. Furthermore, it is an object of the invention to disclose a vehicle, a computer program product and a computer-readable storage medium with which the improved method can be carried out.

With the foregoing and other objects in view there is provided, in accordance with a first aspect of the invention, a method for monitoring a track section for obstacles, wherein for monitoring, the track section is detected by at least one first imaging sensor and at least one second imaging sensor.

Imaging sensors are taken to mean sensors having measured values which can be converted into an image of the environment which is to be monitored, i.e. primarily the track section and the platform edges. These can be, for example, optical cameras, radars, LIDAR and the like.

Where a track section is mentioned in the context of this description of the invention, in this case it is the railroad track, having a permanent way, formed primarily of the rails and the railroad ties (in addition, for example fastening means for the rails) as well as a substructure which provides the subsurface for the railroad ties, for example a ballast or a concrete base. It will readily become clear that the components of the track section form part of the visible surface and thus are also depicted in the imaging method. However, it these components are covered by an object, this may be ascertained in a manner known per se in that the images generated by the imaging method are evaluated. The method can make use, for example, of artificial intelligence generated in a computer-aided manner.

An apparatus is computer-aided or computer-implemented if it has a computing environment, or a method if a computing environment executes at least one method step of the method.

A computing environment is an IT infrastructure, including functional components such as processors, storage units, programs and data which is to be processed by the programs, which is used to execute at least one application which has to fulfil a task. Further functional components can be composed of sensors and actuators, which make interaction of the computing environment with the outside world possible. The IT infrastructure can also be organized as a network of the functional components.

Computing instances embody functional units within a computing environment, which can be assigned to applications (provided, for example, by a number of program modules) and can execute them. When the application is executed, these functional units form physically (for example, computer, processor) and/or virtually (for example, program module) self-contained systems.

Computers are composed of electronic devices, including a plurality of functional components, with data processing properties. Computers can be, for example, clients, servers, handheld computers, communications devices and other electronic devices for data processing, which can have processors and storage units and can also be combined via interfaces to form a network.

Processors can be, for example, transformers, sensors for generating measuring signals or electronic circuits. A processor can be a Central Processing Unit (CPU), a microprocessor, a microcontroller, or a digital signal processor, possibly in combination with a storage unit for storing program commands and data. A processor can also be taken to mean a virtualized processor or a soft CPU.

Storage units can be executed on computer-readable memories in the form of Random-Access Memory (RAM) or data stores (hard disk or data carriers).

Program modules are individual software functional units which make an inventive program sequence of method steps possible. These software functional units can be actualized in a single computer program or in a plurality of computer programs which communicate with each other. The interfaces realized in this connection can be implemented in terms of software within a single processor or in terms of hardware if a plurality of processors is employed.

Interfaces can be realized in terms of hardware, for example wired or as a radio link, or in terms of software, for example as an interaction between individual program modules of one or more computer program(s), and serve to exchange data, preferably in the form of digital datasets or analog signals.

In order to prevent misunderstandings it should be noted at this point that individual features of the claims are consecutively numbered by lowercase Latin letters without consideration being given to the numbering of the claims.

This means that each letter occurs only once in the entire set of claims, and this makes it possible to unambiguously address the relevant features of the claims without citing the claim number. However, for this reason the order of the letters is not important.

According to the invention, it is provided that:
a) the at least one first sensor and the at least one second sensor are aligned with the track section in such a way that each location of the track section is present in one first image each of the at least one first sensor and one second image each of the at least one second sensor,
b) the first images and second images are analyzed in a computer-aided manner for obstacles in the track section,
c) a signal indicating the presence of an obstacle is always generated if the analysis identified an obstacle in the at least one of the first images as well as in the at least one of the second images,
d) a signal indicating the presence of an obstacle, if the analysis identified the obstacle only in the at least one of the first images or only in the at least one of the second images, is only generated when the analysis identified the identified obstacle as an obstacle of a specified critical category, and is not generated when the analysis identified the identified obstacle as an obstacle of a specified non-critical category,
e) a first signal indicating a fault is always generated if the analysis identified the obstacle only in the at least one of the first images or only in the at least one of the second images.

The terms used in this description of the invention have the following meaning:
Where a first sensor and a second sensor are mentioned in the context of this description of the invention, the first sensor can thus be linked to the vehicle and therefore be operated on this vehicle or the first sensor can also be linked to the track section. The second sensor is linked to the track section, and is thus immovably installed so it can be permanently operated at the relevant track section. By contrast, the first sensor on the vehicle can be operated only on the relevant track section when the vehicle passes this track section or, alternatively, is similarly permanently installed. If a plurality of sensors is employed on the vehicle for the inventive purpose, then all of these sensors are first sensors. If a plurality of immovable second sensors is employed on the track section for the inventive purpose, these are all second sensors. If firmly installed first sensors and second sensors are employed on the track section, then these sensors form a group of sensors respectively, with the first group as well as the second group being used to generate redundancy when detecting objects on the track section. The respective first group and second group of sensors are therefore assigned with a view to the fact that an object can always be simultaneously detected by at least one sensor of the first group and at least one sensor of the second group (detection redundancy for objects).
Where detection by way of generating images is mentioned in the context of this description of the invention, then this is intended to mean that the imaging sensor scans the track section or measures existing radiation emanating from the track section. This can take place optically, for example, by way of an image sensor or else, for example, by scanning by using radar, with it being possible for an image to also be generated with the aid of radar scanning.
Where overlapping of the images is mentioned, this relates to the overlapping region, which can preferably also make up 100 % of the two images being considered, having been recorded by a first sensor as well as by a second sensor. In other words, the image was detected redundantly by two image-capturing systems, namely the track-side, immovably linked and the vehicle-side, mobile or a further track-side, immovably linked capturing system. This advantageously produces redundancy, with it being possible for this to be used for disclosure of a failure of the two systems (more on this below). The two systems are thus reciprocally supported in order to permanently check their functional safety (safety).

Within the meaning of the invention, obstacles denote all objects having a presence in the track section which is detected. Examples which should be mentioned are humans, animals or relatively large inanimate objects. Inanimate objects also include plants or parts of plants since they cannot move independently. These obstacles are critical obstacles (because either the obstacles or the vehicle must not be endangered) and can be specified by a critical category which in the context of the inventive method can be assigned to the identified objects. Objects, which are part of the railroad system in the wider sense and cover the track section, such as balise housings, do not actually count as obstacles in the actual sense but can be classified in order to check the failure safety (more on this below) as obstacles of a specified non-critical category. Furthermore, there are (real) obstacles which due to their size do not constitute a danger to the vehicle and do not themselves have to be protected either, for example garbage in the track bed or the like. These obstacles can also be assigned to the non-critical category.

Due to its characteristics, a signal indicating an obstacle should be interpreted such that a foreign body (or an object of the railroad system categorized as a non-critical obstacle) was identified in the track section. This will also be referred to below as an obstacle signal for short. Due to its characteristics, a signal indicating a fault should be interpreted such that a fault is present which results in a foreign body only being identified once. Hence a fault has to exist because the overlapping of the generated images is sufficient for each location of the track section to be present in at least two images.

However, this also means that an identified foreign body influences the development of at least two images. If a foreign body was thus identified only once, a fault is present, which can have different causes, with reference to the proper progression of the method:
1) A foreign body could be positioned at the edge of the image such that it is not depicted completely and is consequently not identified.
2) The image identification in an image could not be accomplished even though the foreign body is positioned completely in the image.
3) An imaging sensor could be defective, for example have failed completely.

The fault signal can thus be interpreted in multiple ways and make different measures necessary. The hardware as well as the software involved in the method can be checked to ensure they are functioning properly (maintenance, for example, can be requested). In addition, the presence of an obstacle is probable, for which reason the obstacle signal is generated in this case too. In other words, the fact that a fault signal is generated is not necessarily interpreted such that a generated obstacle signal was wrongly generated, even if this case cannot be ruled out. In the interest of operational safety (safety), in cases of doubt the inventive procedure is as if the obstacle signal was correctly generated, but only if the obstacle was assigned to the critical category. If the obstacle was assigned to the non-critical category, it can be ignored irrespective of whether its identification was erroneous or sound. In this case it is in fact only the fault analysis which is important in order to guarantee a disclosure of a failure for the inventive sensor system.

One advantage of the invention resides in that the additional disclosure of a failure for the hardware as well as the software involved in the method is firmly implemented in the progression of the method by the redundant generation of obstacle signals. In other words, with a proper progression of the method, an obstacle signal always has to be generated twice, i.e. redundantly, at one sensor layer (also called SL) of the method for the relevant object. If this is not the case, then this points to one of the faults 1) to 3) mentioned above which can be identified at a sensor monitoring layer (also called Sensor Evaluation Layer, SEL for short) of the method. A partial failure of the system therefore makes it possible for it still to be used for the identification of foreign bodies in the track section. This is brought about by the fact that the one-time identification of an object as an obstacle, as explained above, is taken as a reason to generate an obstacle signal, at least if this obstacle belongs to the critical category. The evaluation necessary for this is carried out at a Safety & Availability Interface Layer (SAIL for short). The SAIL is referred to as an intermediate layer because it is at this layer that a decision is made as to how the sensor data generated in the SL is to be dealt with in the subsequent method, considering the evaluation of this data carried out in the SEL (use of the data for the functional safety application, blocking of data and generating an alarm, maintenance measures in the SL, more on this below).

Simultaneously with operation of the track section, the method can be repaired in good time under conditions protected by the SAIL, so normally a complete failure does not occur. For example, a defective camera can be replaced. This increases the operational safety of the method, so it can advantageously also be used in safety-relevant applications such as the monitoring here in the present case of a track section located at a platform. Ideally, the safety levels SIL-1 and SIL-2 applicable to such a task in rail operation can be achieved.

The demands placed on the certification of safety relevant applications, for example in railroad engineering, are very high. According to the international standard IEC 61508, or specifically for the rail sector according to the European standard EN 50129, for safety functions a distinction is made between four Safety Integrity Levels (SIL) or safety requirement levels for the required functional safety (safety). Safety Integrity Level 4 is the highest and Safety Integrity Level 1 the lowest level of safety integrity. The respective safety integrity level influences the confidence interval of a measured value such that the higher the safety integrity level is which is to be satisfied by the respective apparatus, the smaller the confidence interval is. The dimension of the functional safety of the various safety integrity levels may be clearly described by the expected frequency of failure of the safety-relevant system MTBF (Mean Time Between Failures), with this being indicated in years (a). In the case of SIL-1 this lies in the region of 10 . . . 100 a, in the case of SIL-2 in the region of 100 . . . 1,000 a, in the case of SIL-3 in the region of 1,000 . . . 10,000 a, and in the case of SIL-4 in the region of 10,000 . . . 100,000 a.

With the objects in view, there is also provided, according to a further aspect of the invention, a railroad system with a track section, wherein a large number of imaging sensors for monitoring the track section is installed in the railroad system. According to this aspect, it is inventively provided that the railroad system has a computing environment which is configured to carry out a method as claimed in one of the preceding claims. The advantages connected with this aspect of the invention have already been described, with reference being made to these advantages.

With the objects in view, there is additionally provided, according to a further aspect of the invention, a computer program product, containing program commands which can be executed by a computing environment. According to this aspect, it is inventively provided that at least steps b), c), d) and e) of the method according to the invention are executed.

According to the invention, a computer program product, containing program modules, with program commands is thus described, wherein the program modules can run in the same computing instance or a plurality of computing instances of the computing environment. Through the use of the computer program product, which can include one computer program or a plurality of computer programs, it is possible to execute the inventive method and/or its exemplary embodiments respectively and the advantages described above are achieved with the execution.

With the objects in view, there is concomitantly provided, according to a further aspect of the invention, a computer-readable storage medium, containing data which is stored by the storage medium as datasets. According to this aspect, it is inventively provided that the datasets render the computer program product, described above, as claimed in the last preceding claim, executable.

Furthermore, a provision apparatus for storing and/or providing the computer program in the form of a computer-readable storage medium is thus described. The provision apparatus is, for example, a storage unit which stores the computer program and provides it for retrieval. Alternatively or in addition, the provision apparatus is a network service, a computer system, a server system, in particular a shared, for example cloud-based, computer system or virtual computer system, which stores the computer program on a computer-readable storage medium and preferably provides it in the form of a data stream.

The computer program is provided in the form of program datasets describing program modules as a data file, in particular as a download file, or as a data stream, in particular as a download data stream, of the computer program product. The computer program product is transferred, for example, using the provision apparatus into a computing environment, so the inventive method can be executed in one computing instance or a plurality of computing instances of this computing environment.

### EMBODIMENTS OF THE INVENTION

Variants describing developments of the invention will be explained below without limiting the underlying concept of the invention.

According to one variant, aspects of the invention elucidated above are determined in that in step c) according to the invention, a signal indicating the presence of an obstacle, if the analysis identified the obstacle only in the at least one of the first images or only in the at least one of the second images, is also generated when the analysis identified the identified obstacle as neither an obstacle of a specified critical category nor as an obstacle of a specified non-critical category.

One advantage of this variant resides in that the functional safety of the method is increased to the extent that the probability of not identifying critical obstacles due to an incorrection evaluation decreases. If an object can be classified as neither an obstacle of a critical category nor as an obstacle of the non-critical category, it is namely not definite whether the obstacle is critical. In this case, according to this variant, the procedure is therefore such that this obstacle is dealt with like a critical obstacle, and an obstacle signal is generated.

According to one variant, aspects of the invention elucidated above are determined in that each of the second sensors belong to a second group of second sensors disposed at a distance from each other on the track section, wherein the generated images of the second group in a border region respectively adjoin adjacent images respectively, that is to say that the distance of the second sensors from each other is selected such that, by taking into account the image portions which can be depicted by the sensors, an overlapping or unbroken adjoining of the individual images is realized.

Where it is mentioned in the context of this description of the invention that images adjoin one another, this is intended to mean that the contents of the images, which are adjacent to one another, fit together in such a way that that an unbroken overall image is produced. The focus of this overall image is the track section to be monitored which is thus depicted completely and in an unbroken manner in this way in each group of the images. The border region of the images is thus located at the respective edge of these images. In other words, the border region of the images is a connecting region between adjacent images, through which the contents of the images can be joined together in an unbroken manner. Computer-aided algorithms, which make possible such a supplementation of the individual images to form an overall image, are generally known per se and therefore do not need to be explained in more detail at this point.

The edge region of the adjacent images respectively can thus be referred to as the border region, at which region they adjoin the adjoining image respectively. For practical reasons (orientation of the cameras in the railroad stations), an overlapping region can also occur in this connection in the edge region. However, this embodiment of the invention is substantially configured to make use of such an overlapping region not to generate redundant image points in the overall image of a group of images (that is to say, the images generated by the one group of sensors), rather it is used to generate the redundancy of the first sensor or a group of a plurality of first sensors on the vehicle. It should be noted in this connection that when the vehicle moves, an unbroken image of the track section can be generated even with just one first sensor since the imaging first sensor can move along the track section with the vehicle. However, a plurality of first sensors, which form a first group of sensors, can also be employed on the vehicle.

Because, in a manner consistent with the first and second sensors respectively, there are also two groups of images, which in their own right include one unbroken capture of the track section respectively, the redundancy, already explained above, of the depiction of individual image elements is guaranteed, and, more precisely, once in the first group and one in the second group respectively. Of course this does not rule out the possibility of a third group or further groups of images being generated, so threefold or even manifold redundancy is generated.

One advantage of this variant resides in that assigning the sensors to the first group (or use of an individual first sensor) and to the second group respectively means the generation of the redundancy can be effectively controlled when detecting objects in the images. In each group of images these objects are then depicted exactly once, i.e. when a first group and a second group is used, exactly twice. This simplifies the method with which the necessity of fault signals is ascertained. In addition, the occurrence of a fault may be advantageously ascertained with a comparatively high level of certainty.

According to one variant, the aspects of the invention elucidated above are determined in that the function of monitoring the track section by the at least one first sensor is checked in that:
f) as an obstacle a first test structure is disposed in the track section, with it being possible for the structure to be driven over by the vehicle without collision and having a position in the track section which is available to the method as a position dataset,
g) the first images are analyzed in a computer-aided manner for obstacles in the track section,
h) a second signal indicating a fault is output if the analysis does not identify an obstacle at the position marked by the position dataset.

A test structure, which is not dangerous when driven over by the vehicle, requires spatial dimensions which do not result in a collision when the vehicle crosses the test structure. For this reason such a test structure can always be classified as an obstacle of the non-critical category, which is why the rail traffic is not interrupted when this obstacle is identified. These test structures can be, for example, three-dimensional mock-ups of smaller articles. The advantage, that a crossing is not dangerous, is due to the fact that these test structures can be permanently installed in the track bed, so it is possible to check the function of the vehicle-side system with a computing environment for obstacle identification, including the vehicle-side sensor. This advantageously increases the probability of a disclosure of a failure, whereby the probability of undiscovered faults endangering the functional safety of the system is reduced.

Since the position of the test structure is known due to the evaluation of the position dataset, by taking into account the position of the vehicle, which is ascertained in a manner known per se with a functional safety (safety) which is customary for railroad traffic, it is possible to predict where and therewith also when the obstacle embodied as a test structure has to be identified. If the expected identification fails to materialize, this thus points to a fault and the second signal can be generated. In this way a disclosure of a failure for the method which is used and the components employed in the process is advantageously accomplished.

According to one variant, the aspects of the invention elucidated above are determined in that the function of monitoring the track section is checked by the at least one first sensor and the at least one second sensor if a vehicle is located on the track section in that:
i) the current position of the vehicle is made available in a position dataset,
j) the first images and the second images are analyzed in a computer-aided manner for obstacles in the track section,
k) a third signal indicating a fault is output if the analysis does not identify an obstacle in the first images and/or in the second images at the current position marked by the position dataset.

One advantage of this variant resides in that at a platform, vehicles regularly use the track section to make it possible for individuals to get on and off. A test routine can always be carried out then. The vehicle has to be identified in this case. It is thus possible to regularly check the functioning of the method and the hardware components, such as the sensors, involved in its implementation. This advantageously increases the reliability when implementing the method, with the test routine making a disclosure of a failure possible for components of the components involved in the implementation of the method.

According to one variant, the aspects of the invention elucidated above are determined in that manual monitoring of the track section for obstacles is requested by railroad staff as soon as the second signal or the third signal has been evaluated.

This variant of the invention advantageously takes into account the fact that as soon as a fault signal was generated (first signal, second signal or third signal, which indicates a fault), operation of reliable computer-aided obstacle identification is no longer guaranteed. In this case, it is possible to resort to the manual detection of obstacles, for example by the railroad station staff or the train driver. The maximum permitted speed potentially has to be lowered in this case in order to guarantee reliable manual monitoring of the section. Advantageously however, train operation does not have to be stopped completely since the process merely involves checking the section for obstacles, while the train operation per se can still be reliably carried out.

Further details of the invention will be described below on the basis of the drawings. Identical or corresponding elements of the drawings are provided with identical reference numerals respectively in the individual figures and will only be explained multiple times insofar as differences arise between the individual figures.

The exemplary embodiments explained below are preferred embodiments of the invention. In the exemplary embodiments, the described components of the embodiments represent variants of the invention which are to be considered individually and independently of one another respectively and which develop the invention independently of one another respectively also and are thereby also to be regarded as a constituent part of the invention individually or in a combination other than that shown. Furthermore, the described components can also be combined with the variants of the invention described above.

Other features which are considered as characteristic for the invention are set forth in the appended claims.

Although the invention is illustrated and described herein as embodied in a method for monitoring a track section, a railroad system, a computer program product and a computer-readable storage medium, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is a fragmentary, diagrammatic, side-elevational view of an exemplary embodiment of the inventive apparatus of the railroad system with its cause-effect relationships between the functional components which are employed;

FIG. 2 is a block diagram of an exemplary embodiment of a computing environment for the apparatus according to FIG. 1 showing the individual functional components and the interfaces embodied between them, with individual computing instances executing program modules which can run in one or more of the computer(s) represented by way of example respectively and with it being possible for the interfaces shown to be configured accordingly in terms of software in a computer or in terms of hardware between different computers;

FIG. 3 and FIG. 4 are fragmentary, side-elevational and perspective views of examples of a prepared track section with test bodies and images generated in this track section (for example at a railroad crossing) with an individual as an obstacle; and

FIG. 5 is a flowchart of an exemplary embodiment of the inventive method, with it being possible for the method steps shown to be accomplished individually or in groups by program modules and with the computing instances and interfaces being indicated by way of example according to FIG. 2.

### DETAILED DESCRIPTION OF THE INVENTION

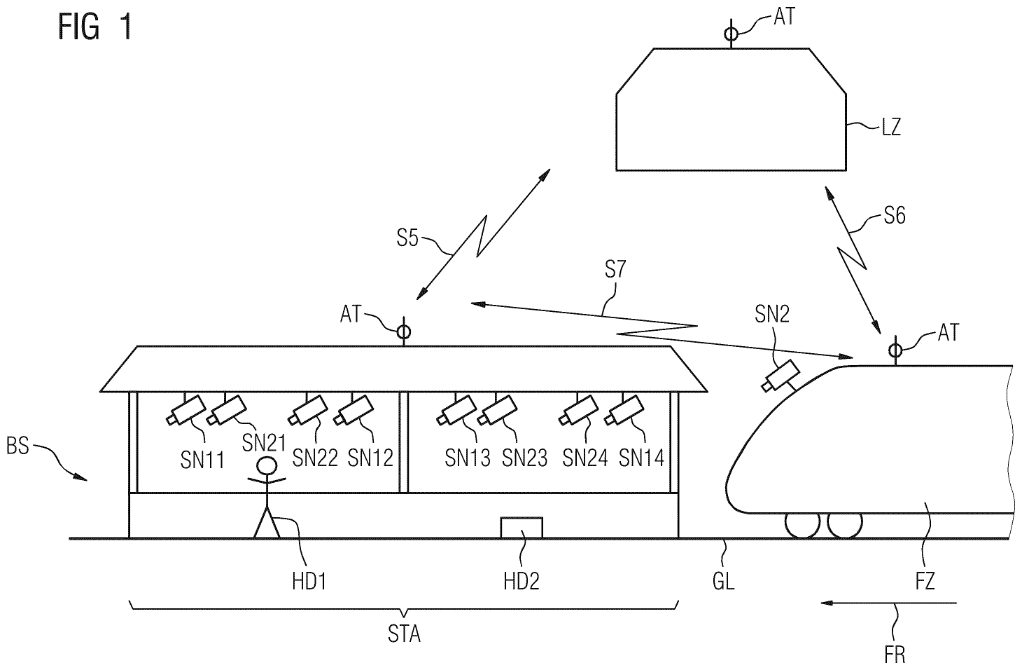

Referring now to the figures of the drawings in detail and first, particularly, to FIG. 1 thereof, there is seen a platform BS and a track GL, on which a vehicle FZ pulls into the platform BS. Furthermore, there is a control center LZ in which, for example, a current actual timetable can be monitored.

Communication between the control center LZ, the vehicle FZ and the platform BS is possible by using antennas AT via a fifth interface S5, a sixth interface S6 and a seventh interface S7.

The platform BS is fitted with four first sensors SN11, SN12, SN13, SN14. These are monitoring cameras in the example according to FIG. 1. They monitor a track section STA of the track GL which is located in front of the platform BS. If an animate obstacle HD1 in the form of a human or an inanimate obstacle HD2 in the form of an object is located on the track GL, this is detected by the sensors. At the same time, a second sensor SN2 is provided on the vehicle FZ and this is oriented in the direction of travel FR with an image axis on the track GL and can thus also detect, as a function of the distance, the animate obstacle as well as the inanimate obstacle HD2 respectively. With regard to the obstacle identification, a redundancy of the imaging-capturing system on the vehicle FZ and on the platform BS is therefore present on the platform BS.

As an alternative to the second sensor SN2, a plurality of second sensors SN21 SN22, SN23, SN24 can also be employed which, in the same number as the first sensors SN11, SN12, SN13, SN14, are disposed with them redundantly respectively in such a way that each of the first and second sensors, which are disposed in pairs, monitor a track section STA simultaneously and therewith redundantly. In this variant, monitoring redundantly is possible at any time and not only when a vehicle FZ pulls into the platform BS.

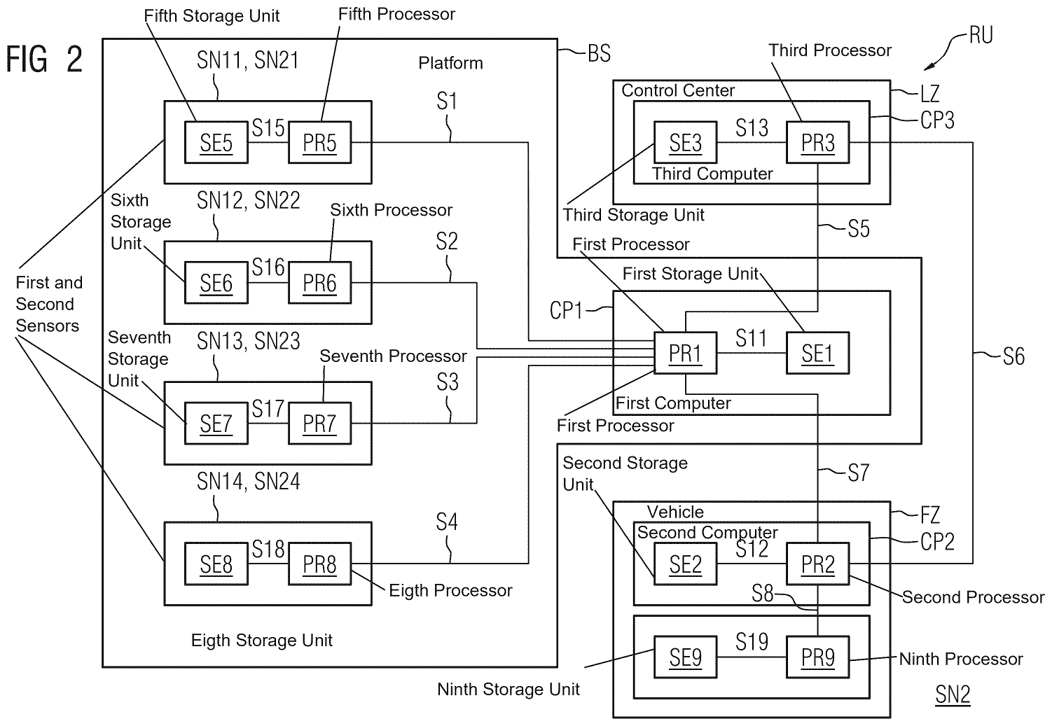

A computing environment RU, in which the inventive method proceeds, can be inferred from joint consideration of FIG. 1 and FIG. 2. The computing instances and functional components which are employed interact with one another by way of interfaces. It can be seen that at the platform BS a first computer CP1 (cf. FIG. 2) communicates with the first sensors SN11, SN12, SN13, SN14. A third computer CP3 is employed in the control center LZ and a second computer CP2 is provided in the vehicle FZ, and this computer communicates with the second sensor SN2 via an eighth interface S8. Of course the computing environments RU formed by the control center LZ, the platform BS and the vehicle FZ can also include a plurality of computers, of which the one represented in FIG. 2 serves merely as an example to illustrate the communication links.

According to FIG. 2, the computers and sensors forming computing instances respectively are represented in more detail. In the case of the first computer CP1, a first processor PR1 is connected to a first storage unit SE1 by an eleventh interface S11. In the case of the second computer CP2, a second processor PR2 is connected to a second storage unit SE2 by a twelfth interface S12. In the case of the third computer CP3, a third processor PR3 is connected to a third storage unit SE3 by a 13th interface S13. The pairs of sensors in the second variant according to FIG. 1 (for example, S11 and S21) are combined into a hardware component according to FIG. 2 (for example as a stereo camera), but could also be embodied, in a manner not represented, by different hardware components with separate processors and storage units respectively. In the case of the sensors SN11, SN21, a fifth processor PR5 is connected to a fifth storage unit SE5 by a 15th interface S15. In the case of the sensors SN12, SN22, a sixth processor PR6 is connected to a sixth storage unit SE6 by a 16th interface S16. In the case of the sensor SN13, SN23, a seventh processor PR7 is connected to a seventh storage unit SE7 by a 17th interface S17. In the case of the sensors SN14, SN24, an eighth processor PR8 is connected to an eighth storage unit SE8 by an 18th interface S18. In the case of the second sensor SN2, a ninth processor PR9 is connected to a ninth storage unit SE9 by a 19th interface S19.

The following can be Inferred from a combination of FIG. 1 and FIG. 2. The fifth processor PR5 of the first sensor SN11, SN12, SN13, SN14 and the first processor PR1 of the first computer CP1 are interconnected by a first interface S1. The sixth processor PR6 of the second sensor SN2 and the first processor PR1 of the first computer CP1 are interconnected by a second interface S2. The seventh processor PR7 of the third sensor and the first processor PR1 of the first computer CP1 are interconnected by a third interface S3. The eighth processor PR8 of the fourth sensor and the first processor PR1 of the first computer CP1 are interconnected by a fourth interface S4. The first processor PR1 and the second processor PR2 are interconnected by the fifth interface S5. Second processor PR2 and the third processor PR3 are interconnected by the sixth interface S6. The first processor PR1 and the second processor PR2 are interconnected by the seventh interface S7.

Where only computers, processors, storage units, sensors or interfaces are mentioned in the context of this description of the invention, the details refer generally to all of the computers, processors, storage units and further functional components named above in detail, which, connected by the interfaces, contribute to the formation of the computing environment RU.

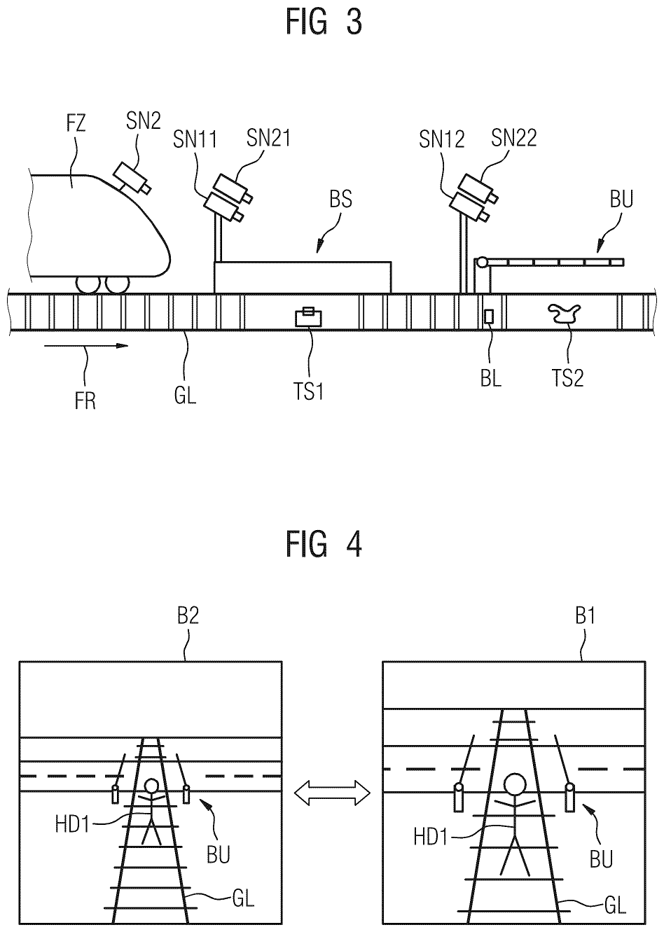

FIG. 3 once again represents a vehicle FZ on the track GL as well as a platform BS and additionally a railroad crossing BU on track GL. First sensors SN11, SN12, SN13, SN14 as well as second sensors SN21, SN22, are likewise employed. In the representation according to FIG. 3, the track GL is represented in a folded manner in the drawing plane in order to show that a first test structure TS1 in the form of a suitcase and a second test structure TS2 in the form of packaging waste are disposed in the track on the subsurface. A balise BL in the track GL can also be used as a test structure. In reality, however, the test structure is a planar arrangement in the track bed, so the vehicle FZ can drive over these test structures without a collision and they can be assigned to a non-critical category, so their identification does not interrupt train operation, no safety measures are required.

FIG. 4 represents how the images recorded as a first obstacle by the first sensors SN11, SN12, SN13, SN14 and the second sensors, SN21, SN22, appears to an individual. A first image B1 and a second image B2 is represented, with the first image B1 having been recorded earlier by the second sensor SN2 on the vehicle FZ as it approaches the railroad crossing BU according to FIG. 3 than the second image B12 by the second sensor SN2 S22. Although the first obstacle is therefore differently-sized due to the distance from the respective imaging sensor, it can still be identified in both cases as the same first obstacle by way of appropriate image processing.

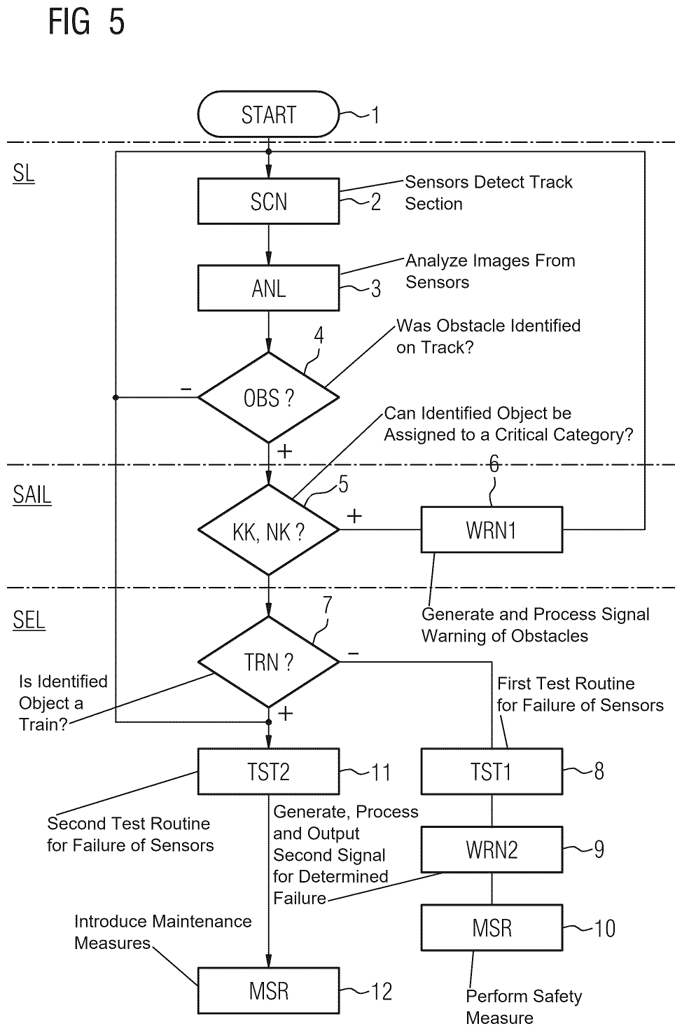

In addition to the test procedure, which will be described in more detail below in relation to FIG. 5, redundancy when checking the test structure can thus also be generated by the first sensors SN11, SN12, SN13, SN14 and the second sensor SN2. The double arrow according to FIG. 4 is intended to indicate that image matching within the meaning of a redundant obstacle identification can also be carried out in the test procedure if the second test structure TS2 was recorded by one of the first sensors SN11, SN12, SN13, SN14 as well as by one of the second sensors.

The inventive method will be explained below by way of example in steps, as represented in the flowchart according to FIG. 5. FIG. 5 also indicates, by way of example by boxes, in which functional components and computing instances according to FIGS. 1 and 2 the individual steps can be carried out. Computer-aided steps take place in the processors (not represented). The reading-out and storing of data in the storage units is represented by way of example. Insofar as the interfaces according to FIGS. 1 and 2 are used, they are also marked in FIG. 5.

The method according to FIG. 5 relates to the operation of a redundant sensor platform for monitoring a track section, with the method being additionally protected with regard to a disclosure of a failure. In other words, with a proper progression of the method, an obstacle signal always has to be generated twice at one Sensor Layer (SL) of the method for the relevant object, i.e. redundantly. If this is not the case, this points to a fault which can be identified at a Sensor Evaluation Layer (SEL for short) of the method. A partial failure of the system therefore means it can still be used to identify foreign bodies in the track section STA, albeit in a type of protected mode. This is due to the fact that even the one-time identification of an object as an obstacle is taken as a reason to generate an obstacle signal, at least when this obstacle belongs to the critical category. The evaluation necessary for this is carried out at a Safety and Availability Interface Layer (SAIL for short). The SAIL is referred to as an intermediate layer because it is at this layer that it is decided how the sensor data generated in the SL has to be dealt with in the subsequent method while taking into account the evaluation of this data carried out in the SEL (use of the data for functionally safe application, blocking the data and generating an alarm, maintenance measures in the SL). This will be explained below on the basis of FIG. 5 where the SL, the SEL and the SAIL are drawn.

The method starts in a first step 1 (START for short).

The track section STA is detected with the aid of the first and/or second sensors (SCN for short) in a second step 2. This produces images on which obstacles can possibly be identified (cf. FIG. 1).

The images generated by the sensors are analyzed (ANL for short) in a third step 3 in order to identify obstacles on the track section STA and to assign them to a critical category when there is a risk of collision and to a non-critical category when there is no risk of a collision. The obstacle identification itself takes place in a manner known per se by way of suitable analysis methods for images generated in a computer-aided manner. For the purpose of obstacle identification, the images are subjected to image processing in a computer-aided manner in a manner known per se and the image contents are analyzed with a view to the presence of obstacles (application of known algorithms for image processing). The assignment to the critical category or the non-critical category, possibly also the unsuccessful assignment, can be linked, for example, to the image data describing the relevant image, or identification data of the relevant images can be assigned to datasets for the classification of the critical category, the non-critical category and possibly an unsuccessful classification.

It is queried in a fourth step 4 whether an obstacle (OBS for short) was identified on the track section STA. If this is not the case, a recursion takes place and step 2 is repeated. If this is the case, however, the process continues with step 5.

A further query is made in a fifth step 5 as to whether the identified obstacle could be assigned to a critical category KK with a risk of collision or if it was not possible to assign a category NK, so a risk of collision cannot be ruled out (KK-NK? For short). If this is the case, the process continues with step 6, if this is not the case, however, the process continues with step 7, with it being possible in this case to start a test procedure for the imaging sensors (more on this below).

A first signal is generated in a sixth step 6 in order to warn of obstacles and it is output or processed further in a computer-aided process (WRN1 for short). The signal results in an interruption to the rail traffic because there is an immediate risk of collision. For example, the warning signal could additionally be output in the control console for a train driver of a train which is pulling in so the train is ready to slow down.

A further query is made in a seventh step 7 as to whether the identified obstacle is a train (TRN? For short). A train is not usually to be interpreted as an obstacle of the critical category because it is part of normal rail operation that trains, for example, drive up to a platform BS or drive on a railroad crossing BU and the safety engineering of the rail operation prevents collisions with a high degree of reliability. Identification therefore takes place only for test purposes in order to improve a disclosure of a failure for the sensors. In this case, the process continues with step 11.

A second test routine (TST2 for short) is worked through in an eleventh step 11. This test routine serves for disclosure of a failure for the first sensors SN11, SN12, SN13, SN14 and second sensors S2 and thus advantageously increases the safety level as the method progresses. Faults in the progression of the method, in particular due to defective sensors, can be identified early in this way and can result, for example, in the introduction of maintenance measures according to step 12 (MSR for short).

In order to be sure that the train may drive up to the platform BS according to schedule, a comparison (not represented in FIG. 5) can be made with a timetable, in particular a current actual timetable, for example in the control center LZ, via the first interface S1. If, according to schedule, the train is not expected at the platform BS, an obstacle signal can be generated because the unscheduled train could represent an obstacle for a scheduled train.

If it is not possible to identify a train, this means a different obstacle from the non-critical category is involved. However, there is no acute risk of a collision with the obstacle, in particular even if the obstacle is a test structure. In this case, the process continues with a first test routine (TST1 for short) according to step 8. This test routine is used for a disclosure of a failure for the first sensors SN11, SN12, SN13, SN14 SN11, SN12, SN13, SN14 and the second sensors and thus advantageously increases the safety level as the method progresses. A second signal is generated as a warning in a ninth step 9 when a failure is determined, which signal can be output or processed in a computer-aided manner. (WRN2 for short).

A safety measure (MSR for short) is carried out in a tenth step 10. A suitable measure has to be derived, for example the manual monitoring of the track section STA by employees of the railroad. Nevertheless a recursion to step 2 can still take place if the fault only occurred temporarily and subsequent recursion loops restore proper functioning of the automatic monitoring for obstacles.

The following is a summary list of reference numerals and the corresponding structure used in the above description of the invention:
AT antennas
B1 first image
B2 second image
BL balise
BS platform
BU railroad crossing
CP1 first computer
CP2 second computer
CP3 third computer
FR direction of travel
FZ vehicle
GL track
HD1 animate obstacle
HD2 inanimate obstacle
LZ control center
PR1 first processor
PR2 second processor
PR3 third processor
PR5 fifth processor
PR6 sixth processor
PR7 seventh processor
PR8 eighth processor
PR9 ninth processor
RU computing environment
S1 first interface
S11 eleventh interface
S12 twelfth interface
S13 13th interface
S15 15th interface
S16 16th interface
S17 17th interface
S18 18th interface
S19 19th interface
S2 second interface
S3 third interface
S4 fourth interface
S5 fifth interface
S6 sixth interface
S7 seventh interface
S8 eighth interface
SE1 first storage unit
SE2 second storage unit
SE3 third storage unit
SE5 fifth storage unit
SE6 sixth storage unit
SE7 seventh storage unit
SE8 eighth storage unit
SE9 ninth storage unit
SN11, SN12, SN13, SN14 first sensor
SN2 second sensor
STA track section
TS1 first test structure
TS2 second test structure

1. A method for monitoring a track section for obstacles by using at least one first imaging sensor and at least one second imaging sensor for detecting the track section during monitoring, the method comprising the following steps:
a) aligning the at least one first imaging sensor and the at least one second imaging sensor with the track section, causing each location of the track section to be present in one first image each, of the at least one first imaging sensor and one second image each, of the at least one second sensor;
b) analyzing the first images and second images in a computer-aided manner for obstacles in the track section;
c) always generating a signal indicating a presence of an obstacle when the analysis has identified an obstacle in at least one of the first images as well as in at least one of the second images;
d) only generating a signal indicating a presence of an obstacle when the analysis has identified the obstacle only in the at least one of the first images or only in the at least one of the second images, when the analysis has identified the identified obstacle as an obstacle of a specified critical category, and not generating the signal when the analysis has identified the identified obstacle as an obstacle of a specified non-critical category; and
e) always generating a first signal indicating a fault when the analysis has identified the obstacle only in the at least one of the first images or only in the at least one of the second images.

2. The method according to claim 1, which further comprises, in step c), also generating a signal indicating a presence of an obstacle when the analysis has identified the obstacle only in the at least one of the first images or only in the at least one of the second images, when the analysis has identified the identified obstacle neither as an obstacle of a specified critical category nor as an obstacle of a specified non-critical category.

3. The method according to claim 1, which further comprises placing each of the second imaging sensors belonging to a second group of second imaging sensors at a distance from each other on the track section, and causing the generated images of the second group in a border region to respectively adjoin adjacent images.

4. The method according to claim 1, which further comprises checking a function of monitoring the track section using the at least one first imaging sensor by:
f) placing a first test structure as an obstacle in the track section, allowing the structure to be driven over by the vehicle without collision and making a position of the first test structure in the track section available to the method as a position dataset;
g) analyzing the first images in a computer-aided manner for obstacles in the track section; and
h) outputting a second signal indicating a fault when the analysis does not identify an obstacle at the position marked by the position dataset.

5. The method according to claim 4, which further comprises checking a function of monitoring the track section using the at least one first imaging sensor and the at least one second sensor when a vehicle is located on the track section by:
i) making a current position of the vehicle available in a position dataset;
j) analyzing the first images and the second images in a computer-aided manner for obstacles in the track section; and
k) outputting a third signal indicating a fault when the analysis does not identify an obstacle in at least one of the first images or the second images at the current position marked by the position dataset.

6. The method according to claim 5, which further comprises requesting manual monitoring of the track section for obstacles by railroad staff as soon as the second signal or the third signal has been evaluated.

7. A railroad system with a track section, the railroad system comprising:
a multiplicity of imaging sensors installed in the railroad system for monitoring the track section; and
a computing environment configured to carry out the method according to claim 1.

8. A non-transitory computer program product, containing program commands which can be executed by a computing environment for executing at least the steps b), c), d) and e) of the method according to claim 1.

9. A non-transitory computer-readable storage medium, containing data stored by the storage medium as datasets, causing the datasets to render the computer program product according to claim 7 executable.
